(19) United States
(12) Patent Application Publication
(10) Pub. No.: US 2003/0025676 A1
(43) Pub. Date: Feb. 6, 2003

(54) Sensor-based menu for a touch screen panel

(75) Inventor: Jeroen Cappendijk, San Jose, CA (US)

Correspondence Address: Corporate Patent Counsel, Philips Electronics North Americ Corporation, 580 White Plains Road, Tarrytown, NY, 10591, US

(73) Assignee: KONINKLIJKE PHILIPS ELECTRONICS N.V.

(21) Appl. No.: 09/922,428

(22) Filed: Aug. 2, 2001

(51) Int. Cl. G09G 5/00

(52) U.S. Cl. 345/173

(57) ABSTRACT

A dynamic graphical user interface specific to touch screen panel is disclosed. The graphical user interface includes a window for showing information content and a graphical menu comprising touch-selectable elements, such as icons or buttons. The graphical user interface is designed so that the graphical menu is displayed when sensing means detects a presence in the vicinity of the panel. The display of the menu causes a modification of the showing of the information content. The menu may cause the window to be reduced or the menu may overlap the window. After a predetermined elapsed period of time, the menu is hidden again and the window restaured.

### FIELD OF THE INVENTION

The invention relates to touch screen panels in general. The invention pertains to a graphical user interface specific to touch screen panels.

### BACKGROUND ART

A touch screen panel is a computer panel that is sensitive to human touch, allowing a user to interact with the computer by touching pictures or words on the screen with his finger or a stylus provided with the panel. Nowadays touch screens are used for, e.g. public information kiosks, computer-based training devices or systems designed to help individuals who have difficulty manipulating a mouse or keyboard. Touch screen panels are designed to be as thin and as light as possible for an easy and versatile usage. Among numerous applications, individuals can use such portable panels everywhere in their home to control their home appliances, watch television or browse the Internet. The consumer electronics industry and the PC industry have adopted a different approach towards touch screen displays than they had, in the past, for regular displays. They have realized that real estate in touch screen displays is a major characteristic. Although touch screen displays are usually smaller than regular displays, icons and active fields need to be larger on touch screen displays to allow convenient use. Selection on touch screen displays is done by placing a finger or a special pen or stylus on user interface (UI) elements such as icons or buttons.

Managing real estate in displays has always been a great concern. Graphical user interfaces have evolved after the years to lead to dynamic displays that automatically change as the individual moves a cursor within the display. U.S. Pat. No. 5,644,737 discloses a method for providing access to a plurality of graphic objects on a computer display. This document describes an auto-hide mode for toolbars. In this mode, a toolbar is completely hidden except for a line a few pixels wide that extends vertically along the edge of the display screen. When the user jams the cursor against the edge of the display screen along which the fully hidden toolbar is disposed, the toolbar is again fully displayed, enabling the user to select any of the graphic objects on the selected toolbar. When the user moves the cursor off the fully displayed toolbar, it returns to the hidden position, i.e. appears to move off the screen or window.

### SUMMARY

It is an object of the invention to provide a dynamic user interface designed for touch screen displays to enable efficient use of available screen space.

It is another object of the invention to design a user interface menu that improves the ease of selection without consuming screen space when not used.

To this end, a graphical user interface of the invention designed for a touch screen panel comprises a window for showing information content and a graphical menu with touch-selectable elements. The graphical menu is designed to be temporarily displayed when sensing means detects a presence in the vicinity of the panel. The display of the graphical menu modifies the showing of information content.

The graphical menu of the invention auto-appears when the sensing means detects a presence in the vicinity of the panel, which automatically causes the graphical menu to appear. The sensing means may detect the individual approaching a stylus towards the panel. Or the sensing device may detect the individual approaching his hand or finger towards the panel. In an embodiment of the invention, the graphical menu is fully or partly hidden while the individual views a video clip or textual content in the window to allow a bigger size window. When the individual approaches his hand to the panel to change content being viewed for example, the graphical menu auto-appears. As a result, the window may be partly reduced or overlapped by the graphical menu and the display of information content is thus modified. An advantage of one or more embodiments of the invention is that such a graphical menu permits to implement touch-selectable elements or buttons larger than usual without taking screen space when they are not being used. Indeed, buttons on the menu can be made larger since these buttons can be hidden most of the time. The invention allows to fully or partly hide the graphical menu and therefore to free screen space while the individual watches content or interacts with content displayed in the window.

In an embodiment of the invention, at least part of the graphical menu is hidden after a predetermined elapsed period of time.

The graphical menu is automatically fully or in part hidden after a given period of time to free screen space for other use. For example, the window may have been reduced in size when the graphical menu was displayed and after a few seconds the window is again displayed in its original size and the menu is automatically hidden. Only a few pixel wide of the graphical menu may be left visible on the screen.

The invention also relates to a touch-screen panel enabling the display of such a graphical user interface.

### BRIEF DESCRIPTION OF THE DRAWING

The invention is explained in further details, by way of examples, and with reference to the accompanying drawings wherein:

FIG. 1 and FIG. 2 illustrate a device of the invention with a graphical menu alternatively displayed and hidden;

FIG. 3 an FIG. 4 illustrate another device of the invention with a graphical menu alternatively displayed and hidden.

Elements within the drawing having similar or corresponding features are identified by like reference numerals.

### DETAILED DESCRIPTION

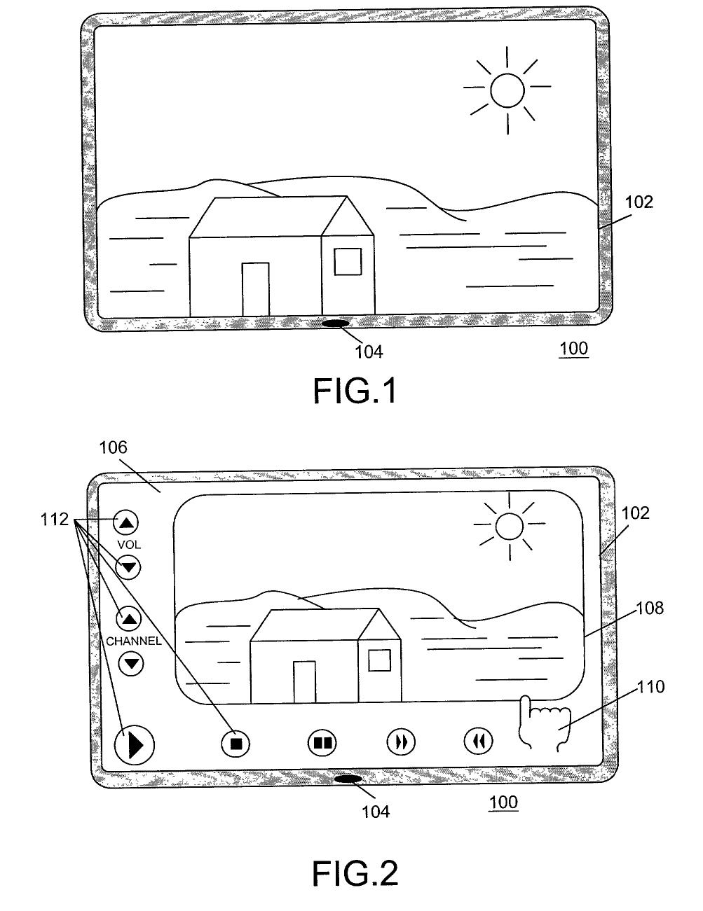

FIG. 1 is a device 100 of the invention. The device 100 comprises a touch-screen panel 102. The panel 102 enables a touch-sensitive graphical user interface. A typical device such as the device 100 may include the touch screen panel 102, a controller and a central processing unit (CPU), both not shown in FIG. 1. The touch screen panel 102 is a clear panel attached or connected to the device 100. The touch screen panel 102 registers touch events and passes signals representing these events to the controller. The controller then processes the signals and sends appropriate data to the CPU. At least three types of touch screen technology can be found. A first technology is referred to as the resistive technology. A resistive touch screen display is coated with a thin metallic electrically conductive and resistive layer. The individual touching this layer causes a change in the electrical current which is registered as a touch event and sent to the controller for processing. A second technology is referred to as the surface wave technology. Surface wave based touch screen displays use ultrasonic waves that pass over the touch screen display. When the display is touched, a portion of the wave is absorbed. This change in ultrasonic wave registers the position of the touch event, which is sent to the controller for processing. A third technology is referred to as the capacitive technology. A capacitive touch screen display is coated with a material that stores electrical charges. When the display is touched, a small amount of charge is drawn to the point of contact. Circuits located at each comer of the display measure the charge and send the information to the controller for processing. Capacitive touch screen displays must be touched by a finger unlike resistive and surface wave displays that can be used with fingers or stylus.

The graphical interface comprises a graphical window 108. In FIG. 1, the window 108 is shown at its biggest possible size and occupies the entire display area of the panel 102. The graphical window 108 is used to view information content. Information content is, e.g., a video clip, Web pages, pictures, textual content, personal agenda pages or a personal calendar. The window 108 shows a video program. For example, the individual watches a television program streamed to the device 100 over the Internet. The device 100 is equipped with a wireless modem providing the device 100 with a wireless connection to the Internet.

The device 100 also comprises a sensor 104, e.g. an infra-red sensor, that can detect a movement in its detecting range. In an embodiment, the sensor 104 is configured to detect the individual's presence in a region being less than 10 centimeters from the sensor 104. In the invention, the sensor 104 enables controlling the display of a graphical menu 106. The menu 106 is displayed when the sensor 104 detects the individual's presence in the vicinity of the sensor 104. In FIG. 1, the sensor 104 has not detected the presence of the individual or the presence of a stylus in its receiving range. Therefore, the menu 106 is hidden. In an embodiment, the detecting range of the sensor 104 may also enable the sensor to detect a presence in a vicinity of a portion only of the panel 102, e.g. the upper part if the sensor is placed in the upper part of the panel 102. In this embodiment, the individual may still interact with interactive content showed in the window 108 without having the menu 106 popping up as he approaches the panel 102.

FIG. 2 shows the same graphical user interface including the menu 106 that auto-appeared on the panel 102 after the individual has approached his hand 110 towards the panel 102. The window 108 is automatically reduced in size to allow the display of the menu 106, which surrounds the window 108. The window 108 still displays the television program received over the Internet. The menu 106 includes various UI elements or buttons 112 that the individual can select by the touch of a finger. The UI elements 112 permit the individual to, e.g., switch the television channel, control the volume and control the playing of a video program.

The menu 106 appears on the panel 102 when the sensor 104 detects the hand 110 of the individual approaching. The menu 106 may be displayed till the hand 110 of the individual is in the detecting range of the sensor 104 and the menu 106 can be hidden when the hand 110 is out of it. In another embodiment, the menu 106 is displayed when the hand 110 of the individual enters the detecting range of the sensor 104. The menu 106 is then temporarily displayed and hidden again after a predetermined elapsed period of time whether the hand 110 of the individual is still in the detecting range of the sensor 104 or not. In order to have the menu 106 fully displayed again, the individual needs to move his hand 110 away from the panel 102 or the sensor 14 and approach it again. As mentioned above, the sensor 104 may also be configured to detect a presence in the vicinity of a specific portion of the panel 102 only, e.g. the lower part of the panel 102.

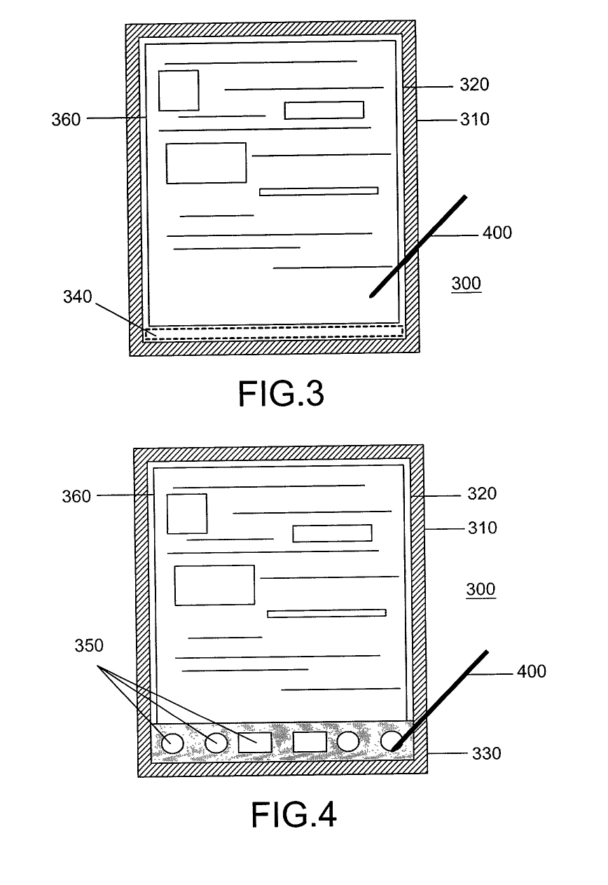

FIG. 3 is another device 300 of the invention. The device 300 is possibly a personal digital assistant, a car navigation system, a handheld computer, a cell phone or the like. The device 300 comprises a touch screen panel 310 sensitive to a pen or stylus 400. A GUI 320 is displayed on the panel 310 allowing the individual to interact and control the display of information content. The GUI 320 includes a window 360 displaying a web page. The GUI 320 also comprises a field 340 acting as a sensing area for the display of a menu bar 330. The menu bar 330 shown in FIG. 4, comprises touch-selectable buttons 350. The menu bar 330 can be displayed in the lower part of the GUI 320. The individual causes the full display of the menu bar 330 by touching anywhere in the sensing field 340. In this embodiment, the menu bar 330 can be displayed for a limited period of time and automatically fully or partly hidden thereafter.

The word “comprising” does not exclude the presence of other elements or steps than those listed in a claim.

I claim:

1. A graphical user interface designed for a touch screen panel, the graphical user interface comprising:
a window for showing information content; and,
a graphical menu with at least one touch selectable element, the menu being temporarily displayed when sensing means detects a presence in the vicinity of the panel and the display of the graphical menu modifying the showing of information content.

2. The graphical user interface of claim 1, wherein part of the graphical menu is hidden when the sensing means does not detect a presence in the vicinity of the panel.

3. The graphical user interface of claim 1, wherein part of the graphical menu is hidden after an elapsed period of time.

4. The graphical user interface of claim 1, wherein part of the graphical menu is hidden after an elapsed period of time of no presence detection by the sensing means.

5. The graphical user interface of claim 1, wherein part of the graphical menu is hidden upon selection by an individual of the touch-selectable element.

6. The graphical user interface of claim 1, wherein the sensing means detects a presence in response to a pressure applied to a portion of the panel.

7. The graphical user interface of claim 1, wherein the sensing device detects a presence in response to a change of conductivity in a portion of the panel.

8. The graphical user interface of claim 1, wherein the sensing device detects a presence in response to a change of a transmission of signals through a portion of the panel.

9. The graphical user interface of claim 1, wherein the graphical menu is displayed when the sensing means detects a movement of an individual in a spatial detecting range of the sensing means.

10. The graphical user interface of claim 1, wherein the graphical menu is a toolbar.

11. The graphical user interface of claim 1, wherein the window is reduced when the graphical menu is displayed.

12. The graphical user interface of claim 1, wherein the graphical menu partly overlaps the window when the graphical menu is displayed.

13. A touch-screen panel enabling to display:
a window for showing information content; and,
a graphical menu with at least one touch selectable element, the menu being temporarily displayed when sensing means detects a presence in the vicinity of the panel and the display of the graphical menu modifying the showing of information content.

14. The touch-screen panel of claim 13, wherein part of the graphical menu is hidden after an elapsed period of time.

15. The touch screen panel of claim 13, wherein the window is reduced when the graphical menu is displayed.

16. The touch screen panel of claim 13, wherein the graphical menu partly overlaps the window when the graphical menu is displayed.

17. A device comprising:
a touch screen panel enabling the display of:
a window for showing information content; and,
a graphical menu with at least one touch selectable element;
sensing means for detecting a presence in a vicinity of the panel, and wherein the menu is temporarily displayed when the sensing means detects a presence in the vicinity of the panel and wherein the display of the graphical menu modifies the showing of information content.

18. The device of claim 17, wherein part of the graphical menu is hidden after an elapsed period of time.

19. The device of claim 17, wherein the window is reduced when the graphical menu is displayed.

20. The device of claim 17, wherein the graphical menu partly overlaps the window when the graphical menu is displayed.

21. A software application for controlling the display of a graphical user interface on a touch screen panel, the graphical user interface comprising:
a window for showing information content; and,
a graphical menu with at least one touch selectable element, the menu being temporarily displayed when sensing means detects a presence in the vicinity of the panel and the display of the graphical menu modifying the showing of information content.
